(19) United States
(12) Patent Application Publication
(10) Pub. No.: US 2013/0297785 A1
(43) Pub. Date: Nov. 7, 2013

(54) USER STATUS ANALYZING METHOD AND APPARATUS USING ACTIVITY HISTORY

(71) Applicant: Electronics and Telecommunications Research Institute, (US)

(72) Inventors: Young Sung SON, Daejeon (KR); Jun Hee PARK, Daejeon (KR)

(73) Assignee: Electronics and Telecommunications Research Institute, Daejeon (KR)

(21) Appl. No.: 13/887,112

(22) Filed: May 3, 2013

(30) Foreign Application Priority Data
May 4, 2012 (KR) 10-2012-0047562
Mar. 21, 2013 (KR) 10-2013-0030144

(51) Int. Cl. H04L 29/08

(52) U.S. Cl. CPC H04L 67/22
USPC 709/224

(57) ABSTRACT

A user status analyzing apparatus including an activity history acquiring module configured to acquire, in a form of activity history time series data, activity history information in which a user activity is written through a home network to which a plurality of sensor devices is connected; an activity history storage configured to store the plurality of activity history time series data obtained by the activity history acquiring module; and an activity history analyzing module configured to analyze a user status depending on a correlation and characteristics perceived on a basis of the plurality of activity history time series data stored in the activity history storage.

### RELATED APPLICATIONS

This application claims the benefit of Korean Patent Application Nos. 10-2012-0047562, filed on May 4, 2012 and 10-2013-0030144, filed on Mar 21, 2013, which are hereby incorporated by reference as if fully set forth herein.

### FIELD OF THE INVENTION

The present invention relates to a user status analyzing apparatus and method using an activity history, and more particularly, to a user status analyzing apparatus and method using an activity history, which is capable of obtaining and analyzing kinds of history related to user activities to determine a user status.

### BACKGROUND OF THE INVENTION

Conventionally, a user status can be determined by measuring current status values for particular items and comparing the measured current status values with rules defined in advance.

When the items to be measured are added, it is needed to additionally define rules to analyze the status values.

Accordingly, it was difficult to precisely determine a user status changing in real time and the entire system should be upgraded in case of adding items to be measured.

### SUMMARY OF THE INVENTION

In view of the above, the present invention provides a user status analyzing apparatus using an activity history and method thereof, capable of determining a user status by obtaining and analyzing kinds of history related to user activities in a home network environment to which a plurality of sensor devices is connected.

In accordance with an exemplary embodiment of the present invention, there is provided A user status analyzing apparatus includes: an activity history acquiring module configured to acquire, in a form of activity history time series data, activity history information in which a user activity is written through a home network to which a plurality of sensor devices is connected; an activity history storage configured to store the plurality of activity history time series data obtained by the activity history acquiring module; and an activity history analyzing module configured to analyze a user status depending on a correlation and characteristics perceived on a basis of the plurality of activity history time series data stored in the activity history storage.

In the embodiment, wherein the activity history acquiring module is configured to acquire at least one of indoor status information including temperature, humidity, illumination or noise level of a room, sleep status information including sleep amount or sleep quality of the user, home appliances drive information including a refrigerator, a microwave oven or a water purifier, movement information including motion speed, motion level, positional status or motion property of the user, diet information including food taken by the user, medical information including a value measured by a blood sugar meter or a blood pressure meter, or emotion information including a condition of the user.

In the embodiment, wherein the activity history acquiring module acquires card use information of the user which is a kind of the activity history information from a card transaction management server connected through a communication network.

In the embodiment, wherein the activity history acquiring module acquires terminal use information of the user which is a kind of the activity history information from a mobile communication terminal connected through a communication network.

In the embodiment, wherein the activity history acquiring module acquires foodstuff purchase information of the user which is a kind of the activity history information from a foodstuff sale management server connected through a communication network.

In the embodiment, wherein the activity history analyzing module provides information so that the perceived status of the user can be recognized.

In accordance with another exemplary embodiment, there is provided A user status analyzing method includes: acquiring, in a form of activity history time series data, activity history information in which a user activity history is recorded through a home network to which a plurality of sensor devices is connected; analyzing a correlation and characteristics for a plurality of activity history time series data; and perceiving a user status depending on the correlation and characteristics determined.

In the embodiment, wherein said acquiring activity history information comprises obtaining at least one of indoor status information including temperature, humidity, illumination or noise level of a room, sleep status information including sleep amount or sleep quality of the user, home appliances drive information including a refrigerator, a microwave oven or a water purifier, movement information including motion speed, motion level, positional status or motion characteristic of the user, diet information including food taken by the user, medical information including a value measured by a blood sugar meter or a blood pressure meter, or emotion information including a condition of the user.

In the embodiment, wherein said acquiring activity history information comprises acquiring card use information of the user which is a kind of the activity history information from a card transaction management server connected through a communication network.

In the embodiment, wherein said acquiring activity history information comprises acquiring terminal use information of the user which is a kind of the activity history information from a mobile communication terminal connected through a communication network.

In the embodiment, wherein said acquiring activity history information comprises acquiring foodstuff purchase information of the user which is a kind of the activity history information from a foodstuff sale management server connected through a communication network.

In the embodiment, wherein said perceiving a user status comprises providing information so that the perceived status of the user can be recognized.

In accordance with the embodiments of the present invention, there is provided user status information depending on a result made by obtaining and analyzing kinds of history related to user activities in a home network environment to which a plurality of sensor devices is connected. Therefore, it is possible to precisely determine a user status changing in real time and easily to add items to be measured by adding a sensor device or the like.

Accordingly, the embodiment of the present invention provides an environment that can provide personalized intellectual application service that is more suitable to a user by recognizing a lifestyle of the user or the like.

### BRIEF DESCRIPTION OF THE DRAWINGS

The above and other objects and features of the present invention will become apparent from the following description of the embodiments given in conjunction with the accompanying drawings, in which:

FIG. 1 shows a configuration of a user status analyzing apparatus in accordance with an exemplary embodiment of the present invention;

FIG. 2 is a detailed block diagram of an activity history acquiring module of a user status analyzing apparatus in accordance with an exemplary embodiment of the present invention;

FIG. 3 is a detailed block diagram of an activity history analyzing module of a user status analyzing apparatus in accordance with an exemplary embodiment of the present invention;

FIG. 4 is a flow chart illustrating a user status analyzing method using a user status analyzing apparatus in accordance with an exemplary embodiment of the present invention; and

FIG. 5 is a network diagram of a user monitoring system to which a user status analyzing apparatus in accordance with an embodiment of the present invention is applied.

### DETAILED DESCRIPTION OF THE EMBODIMENTS

The advantages and features of embodiments and methods of accomplishing the present invention will be clearly understood from the following described description of the embodiments taken in conjunction with the accompanying drawings. However, the present invention is not limited to those embodiments and may be implemented in various forms. It should be noted that the embodiments are provided to make a full disclosure and also to allow those skilled in the art to know the full range of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, embodiments of the present invention will be described in detail with reference to the accompanying drawings so that they can be readily implemented by those skilled in the art.

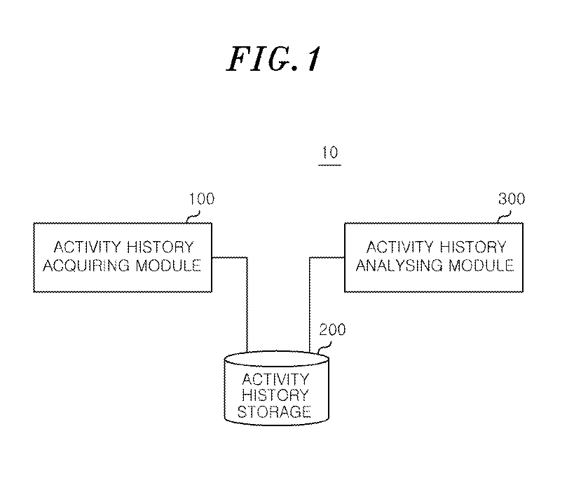

FIG. 1 shows a configuration of a user status analyzing apparatus in accordance with an exemplary embodiment of the present invention.

As shown in FIG. 1, the user status analyzing apparatus 10 includes an activity history acquiring module 100, activity history storage 200 and an activity history analyzing module 300.

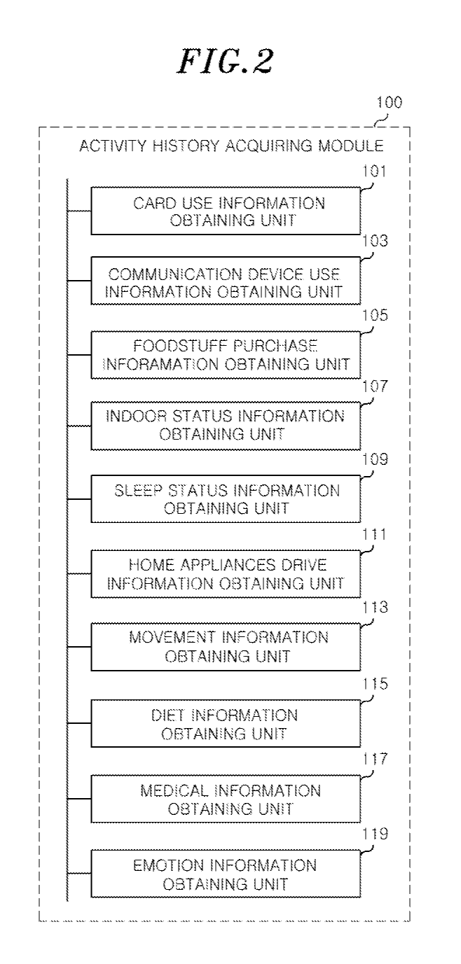

The activity history acquiring module 100 acquires activity history information in which user activities are recorded, in a form of activity history time series data of an activity history, through a home network to which a plurality of sensor devices is connected. Detailed components of such an activity history acquiring module 100 will be described below with reference to FIG. 2.

The activity history storage 200 stores a plurality of activity history time series data obtained by the activity history acquiring module 100.

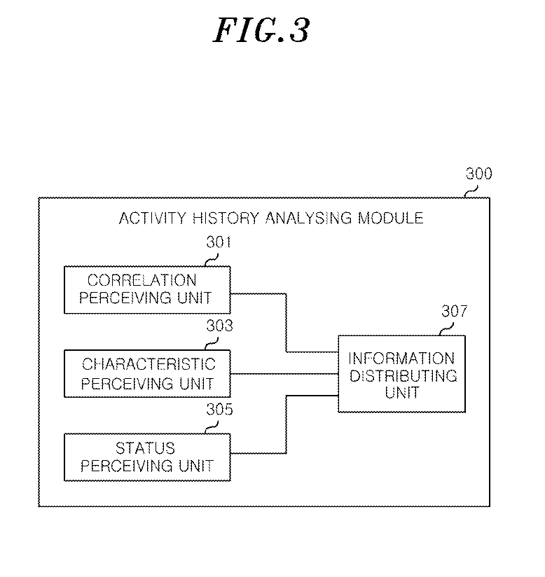

The activity history analyzing module 300 analyzes a correlation and characteristics for the plurality of activity history time series data that are stored in the activity history storage 200 to determine a user status in accordance with the analyzed result. Detailed components of the activity history analyzing module 300 will be described below with reference to FIG. 3.

FIG. 2 is a detailed block diagram of an activity history acquiring module of a user status analyzing apparatus in accordance with an exemplary embodiment of the present invention.

As shown in FIG. 2, the activity history acquiring module 100 includes a card use information obtaining unit 101, a communication device use information obtaining unit 103, a foodstuff purchase information obtaining unit 105, an indoor status information obtaining unit 107, a sleep status information obtaining unit 109, a home appliances drive information obtaining unit 111, a movement information obtaining unit 113, a diet information obtaining unit 115, a medical information obtaining unit 117 and an emotion information obtaining unit 119.

The card use information obtaining unit 101 obtains card use information of a user which is a kind of activity history information from a card transaction management server connected through a communication network.

The communication device use information obtaining unit 103 obtains terminal use information of a user which is a kind of activity history information from a mobile communication terminal connected through the communication network.

The foodstuff purchase information obtaining unit 105 obtains foodstuff purchase information of a user which is a kind of activity history information from a foodstuff sale management server connected through a communication network.

The indoor status information obtaining unit 107 obtains indoor status information including temperature, humidity, luminance, or noise level in a room in a form of activity history time series data.

The sleep status information obtaining unit 109 obtains sleep status information including sleep amount or sleep quality of a user in a form of activity history time series data.

The home appliances drive information obtaining unit 111 obtains home appliances drive information including a refrigerator, a microwave oven, or a water purifier in a form of activity history time series data.

The sport information obtaining unit 113 obtains movement information including motion speed, motion level, positional information, or motion property of a user in a form of activity history time series data.

The diet information obtaining unit 115 obtains diet information including the food taken by a user in a form of activity history time series data.

The medical information obtaining unit 117 obtains medical information including a value measured by a blood sugar meter or a blood pressure meter in a form of activity history time series data.

The emotion information obtaining unit 119 obtains emotion information including a condition of a user in a form of activity history time series data.

FIG. 3 is a detailed block diagram of an activity history analyzing module of a user status analyzing apparatus in accordance with an embodiment of the present invention.

As shown in FIG. 3, an activity history analyzing module 300 includes a correlation perceiving unit 301, a characteristic perceiving unit 303, a status perceiving unit 305 and an information providing unit 307.

The correlation perceiving unit 301 perceives a correlation for a plurality of activity history time series data that are stored in an activity history storage 200.

The characteristic perceiving unit 303 perceives characteristics for the plurality of activity history time series data stored in the activity history storage 200.

The status perceiving unit 305 perceives statuses of a user depending on a correlation perceived by the correlation perceiving unit 301 and characteristics perceived by the characteristic perceiving unit 303.

The information providing unit 307 provides information in order that a user can recognize the status of the user perceived by the status perceiving unit 305.

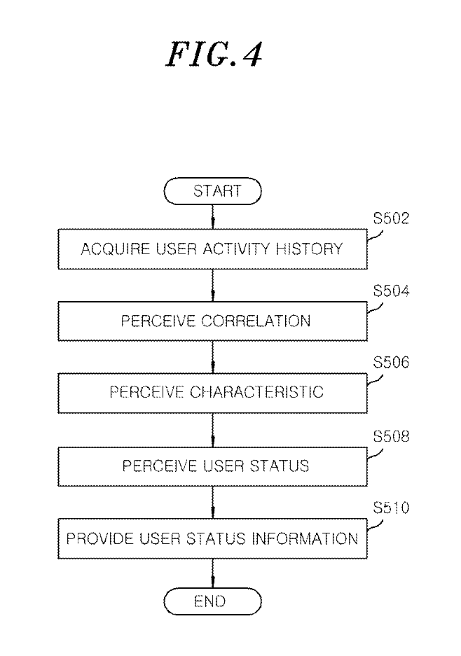

FIG. 4 is a flow chart illustrating a user status analyzing method using a user status analyzing apparatus in accordance with an exemplary embodiment of the present invention.

As shown in FIG. 4, the user status analyzing method includes obtaining activity history information in which user activities are recorded through a home network to which a plurality of sensor devices is connected in a form of activity history time series data in operation S502, perceiving a correlation and characteristics for a plurality of activity history time series data in operations S504 and S506, perceiving a user status depending on the correlation and characteristics determined in operation S508, and providing information to recognize the user status determined in operation S510.

Hereinafter, a description on a user status analyzing method using a user status analyzing apparatus will be given in accordance with an exemplary embodiment of the present invention with reference to FIGS. 1 to 5.

First, the activity history acquiring module 100 acquires activity history information in which user activities are recorded through a home network 20 to which a plurality of sensor devices is connected, in a form of activity history time series data in operation S502.

The card use information obtaining unit 101 in the activity history acquiring module 100 obtains card use information of a user which is a kind of activity history information from a card transaction management server connected through a communication network, and the communication device use information obtaining unit 103 obtains terminal usage information of a user which is a kind of activity history information from a mobile communication terminal connected through the communication network.

The foodstuff purchase information obtaining unit 105 in the activity history acquiring module 100 obtains foodstuff purchase information of a user which is a kind of activity history information from a foodstuff sale management server connected through a communication network, and the indoor status information obtaining unit 107 obtains indoor status information including temperature, humidity, illuminance, or noise level in a room in a form of activity history time series data.

The sleep status information obtaining unit 109 in the activity history acquiring module 100 obtains sleep status information including a sleep amount or a sleep quality of a user in a form of activity history time series data, and the home appliances drive information obtaining unit 111 obtains home appliances drive information including a refrigerator, a microwave oven or a water purifier in a form of activity history time series data.

The movement information obtaining unit 113 in the activity history acquiring module 100 obtains movement information including a motion speed, a motion level, a position status or a motion property of a user in a form of activity history time series data, and a diet information obtaining unit 115 obtains diet information including the food taken by a user in a form of activity history time series data.

The medical information obtaining unit 117 in the activity history acquiring module 100 obtains medical information including a value measured by a blood sugar meter or a blood pressure meter in a form of activity history time series data in a form of activity history time series data, and the emotion information obtaining unit 119 obtains emotion information including a condition of a user in a form of activity history time series data. For example, the emotion information obtaining unit 119 may transmit questionnaire to a mobile communication terminal of a user or the like, receive the questionnaire formed by the user in response thereto and then obtain emotion information of a user depending on the contents of the questionnaire.

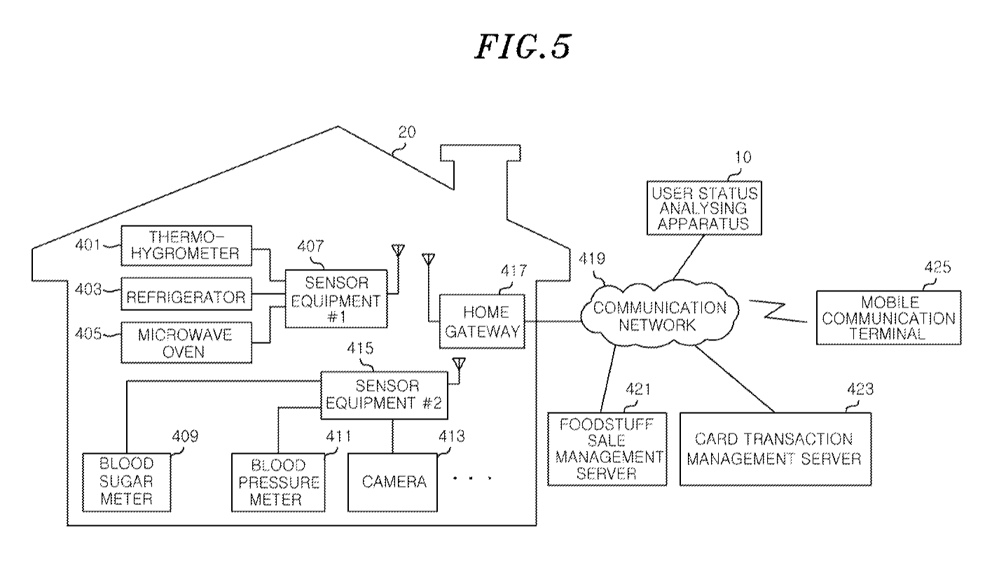

FIG. 5 is a network diagram of a user monitoring system to which a user status analyzing apparatus 10 of the embodiment is applied. As shown, the user status analyzing apparatus 10 obtains activity history information in which user activities are recorded through a home network 20, a foodstuff sale management server 421, a card transaction management server 423 and a mobile communication terminal 425, which are connected through a communication network 419 such as the Internet.

As described above, the activity history acquiring module 100 of the user status analyzing apparatus 10 acquires, in a form of activity history time series data, indoor status information including temperature, humidity, illumination or noise level of a room, sleep status information including a sleep amount or a sleep quality of the user, home appliances drive information including a refrigerator, a microwave oven or a water purifier, movement information including a motion speed, a motion level, a position status or a motion property of the user, diet information including the food taken by the user, medical information including a value measured by a blood sugar meter or a blood pressure meter, or emotion information including a condition of the user, through the home network 20.

To do this, a first and second sensor equipments 407 and 415 that construct the home network 20 obtain activity history information in which user activities are recorded from sensor devices installed in a home such as a thermo-hygrometer 401, a refrigerator 403, a microwave oven 405, a blood sugar meter 409, a blood pressure meter 411, and a camera 413, create activity history time series data by arranging the obtained activity history information in time sequence, and transmit the created activity history time series data to a home gateway 417.

For example, the first sensor equipment 407 measures use frequency of the refrigerator 403 or the microwave oven 405 based on the time-wise to create activity history time series data of the user and activity history time series data of the user depending on temperature and humidity in the home measured by the thermo-hygrometer 401. When the user uses a blood sugar meter 409 or the blood pressure meter 411, the second sensor equipment 415 creates activity history time series data including the value measured by the meter. Further, when a camera 413 takes an indoor picture, the second sensor equipment 415 extracts kinds of information such as motion level and speed, sleep amount and sleep quality, and the taken food of the user by analyzing the picture, and creates activity history time series data. While FIG. 5 illustrates two sensor equipments 407 and 415, such sensor equipments may be added in accordance with installation positions and operational characteristics of the sensor devices such as the thermo-hygrometer 401 and the blood sugar meter 409. For example, another sensor device may measure use frequency and use amount of a water purifier and/or a coffee machine based on the time-wise to create activity history time series data including these information.

Further, a home gateway 417, which constructs the home network 20, receives activity history time series data from the first and second sensor equipments 407 and 415, groups the received activity history time series data by the hour and transmits them to the user status analyzing apparatus 10 through the communication network 419. Otherwise, when the activity history storage 200 that constructs the user status analyzing apparatus 10 is realized in a form of a cloud server, the home gateway 417 may directly transmit the activity history time series data that are grouped by the hour to the cloud server and store them.

Further, the activity history acquiring module 100 of the user status analyzing apparatus 10 acquires foodstuff purchase information of a user from the foodstuff sale management server 421 to create dietary life information of the user and activity history time series data including such dietary life information. Further, the activity history acquiring module 100 acquires terminal use information including webpage use history of a user and the like from the mobile communication terminal 425 to create activity history time series data including information on motion level and speed, webpage use property of the user for a day or during a predetermined time and the like. In addition, the activity history acquiring module 100 acquires card use information from a card transaction management server 423. Then, when identifying the frequency and amount of user's eating out, the activity history acquiring module 100 creates activity history time series data including such information.

The activity history storage 200 stores a plurality of activity history time series data acquired by the activity history acquiring module 100.

Next, a correlation perceiving unit 301 of the activity history analyzing module 300 perceives a correlation for a plurality of activity history time series data stored in the activity history storage 200 in operation S504.

Further, a characteristic perceiving unit 303 of the activity history analyzing module 300 perceives characteristics for the plurality of activity history time series data stored in the activity history storage 200.

As such, the activity history analyzing module 300 compares and analyzes activity history time series data to extract their correlation, process matters, similar matters, association, common characteristics, periodic characteristics, tendency according to the time, and singular point out of general values.

Next, a status perceiving unit 305 of the activity history analyzing module 300 perceives a status of the user according to a correlation perceived by the correlation perceiving unit 301 and the characteristics perceived by the characteristic perceiving unit 303. For example, the status perceiving unit 305 may perceive a change of symptom or the like of a user (e.g., a patient) having diabetes or other diseases on the basis of correlation and characteristics perceived in operation in operation S508.

Then, an information providing unit 307 of the activity history analyzing module 300 provides user status information through an output device such as a monitor or a speaker in order that a user or other person can recognize a user status perceived by the status perceiving unit 305 in operation S510.

The combinations of the each block of the block diagram and each step of the flow chart may be performed by computer program instructions. Because the computer program instructions may be loaded on a general purpose computer, a special purpose computer, or other processor of programmable data processing equipment, the instructions performed through the computer or other processor of programmable data processing equipment may generate the means performing functions described in the each block of the block diagram and each step of the flow chart. Because the computer program instructions may be stored in the computer available memory or computer readable memory which is capable of intending to a computer or other programmable data processing equipment in order to embody a function in a specific way, the instructions stored in the computer available memory or computer readable may produce a manufactured item involving the instruction means performing functions described in the each block of the block diagram and each step of the flow chart. Because the computer program instructions may be loaded on the computer or other programmable data processing equipment, the instructions performing the computer or programmable data processing equipment may provide the steps to execute the functions described in the each block of the block diagram and each step of the flow chart by a series of operational steps being performed on the computer or programmable data processing equipment, thereby a process executed by a computer being generated.

Moreover, the respective blocks or the respective sequences may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A user status analyzing apparatus comprising:
an activity history acquiring module configured to acquire, in a form of activity history time series data, activity history information in which a user activity is written through a home network to which a plurality of sensor devices is connected;
an activity history storage configured to store the plurality of activity history time series data obtained by the activity history acquiring module; and
an activity history analyzing module configured to analyze a user status depending on a correlation and characteristics perceived on a basis of the plurality of activity history time series data stored in the activity history storage.

2. The apparatus of claim 1, wherein the activity history acquiring module is configured to acquire at least one of indoor status information including temperature, humidity, illumination or noise level of a room, sleep status information including sleep amount or sleep quality of the user, home appliances drive information including a refrigerator, a microwave oven or a water purifier, movement information including motion speed, motion level, positional status or motion property of the user, diet information including food taken by the user, medical information including a value measured by a blood sugar meter or a blood pressure meter, or emotion information including a condition of the user.

3. The apparatus of claim 1, wherein the activity history acquiring module acquires card use information of the user which is a kind of the activity history information from a card transaction management server connected through a communication network.

4. The apparatus of claim 1, wherein the activity history acquiring module acquires terminal use information of the user which is a kind of the activity history information from a mobile communication terminal connected through a communication network.

5. The apparatus of claim 1, wherein the activity history acquiring module acquires foodstuff purchase information of the user which is a kind of the activity history information from a foodstuff sale management server connected through a communication network.

6. The apparatus of claim 1, wherein the activity history analyzing module provides information so that the perceived status of the user can be recognized.

7. A user status analyzing method comprising:
acquiring, in a form of activity history time series data, activity history information in which a user activity history is recorded through a home network to which a plurality of sensor devices is connected;
analyzing a correlation and characteristics for a plurality of activity history time series data; and
perceiving a user status depending on the correlation and characteristics determined.

8. The method of claim 7, wherein said acquiring activity history information comprises obtaining at least one of indoor status information including temperature, humidity, illumination or noise level of a room, sleep status information including sleep amount or sleep quality of the user, home appliances drive information including a refrigerator, a microwave oven or a water purifier, movement information including motion speed, motion level, positional status or motion characteristic of the user, diet information including food taken by the user, medical information including a value measured by a blood sugar meter or a blood pressure meter, or emotion information including a condition of the user.

9. The method of claim 7, wherein said acquiring activity history information comprises acquiring card use information of the user which is a kind of the activity history information from a card transaction management server connected through a communication network.

10. The method of claim 7, wherein said acquiring activity history information comprises acquiring terminal use information of the user which is a kind of the activity history information from a mobile communication terminal connected through a communication network.

11. The method of claim 7, wherein said acquiring activity history information comprises acquiring foodstuff purchase information of the user which is a kind of the activity history information from a foodstuff sale management server connected through a communication network.

12. The method of claim 7, wherein said perceiving a user status comprises providing information so that the perceived status of the user can be recognized.
